(19) United States
(12) Patent Application Publication
(10) Pub. No.: US 2023/0190033 A1
(43) Pub. Date: Jun. 22, 2023

(54) HOT BEVERAGE BREWING APPARATUS

(71) Applicant: Bravilor Bonamat B.V., Heerhugowaard (NL)

(72) Inventors: Nico Simon Breebaart, Heerhugowaard (NL); Merlijn Welkamp, Heerhugowaard (NL); Kuno Teunissen, Heerhugowaard (NL)

(21) Appl. No.: 18/147,968

(22) Filed: Dec. 29, 2022

Related U.S. Application Data
(63) Continuation of application No. PCT/NL2021/050426, filed on Jul. 5, 2021.

(30) Foreign Application Priority Data
Jul. 3, 2020 (NL) 2025985

(51) Int. Cl. A47J 31/52; A47J 31/46; A47J 31/54

(52) U.S. Cl. CPC A47J 31/5255; A47J 31/469; A47J 31/545

(57) ABSTRACT

A hot beverage brewing apparatus comprising a water input, a water pump connected to the water input and provided with a first control loop for controlling a flow generated by the water pump, a thermal heater connected to the water pump and provided with a second control loop for controlling the heating by the thermal heater of the water supplied by the water pump, and a brewer unit connected to the thermal heater with a first outlet for the hot beverage, wherein the thermal heater is provided with a second outlet for steam.

### CROSS-REFERENCE TO RELATED APPLICATIONS

This application is a continuation application of International Patent Application No. PCT/NL2021/050426, titled “A HOT BEVERAGE BREWING APPARATUS”, filed on Jul. 5, 2021, which claims priority to and the benefit of Netherland Patent Application No. 2025985, titled “A HOT BEVERAGE BREWING APPARATUS”, filed on Jul. 3, 2020, and the specification and claims thereof are incorporated herein by reference.

### BACKGROUND OF THE INVENTION

### Field of the Invention

The invention relates to a hot beverage brewing apparatus comprising a water input, a water pump connected to the water input and provided with a first control loop for controlling a flow generated by the water pump, a thermal heater connected to the water pump and provided with a second control loop for controlling the heating by the thermal heater of the water supplied by the water pump, and a brewer unit connected to the thermal heater with a first outlet for the hot beverage.

### Background Art

EP-A-3 135 162 discloses a hot beverage brewing apparatus.

Discussion of any prior publications or references is given for a more complete background and is not to be construed as an admission that such publications are prior art for purposes of determining patentability.

### BRIEF SUMMARY OF THE INVENTION

It is an object of the invention to expand the application possibilities of the known hot beverage brewing apparatus at limited costs and reduced CO2 footprint.

The hot beverage brewing apparatus of the invention is provided with a second outlet for steam, and that the first control loop for controlling the flow generated by the water pump comprises a zero cross detection circuit connected to a power input line of a power circuit which provides power to the water pump to detect and select one of the two halves of a power cycle present on the power line, said control loop further comprising a driving circuit cooperating with the zero cross detection circuit, and said control loop further comprising a switch in the power circuit of the water pump, which switch is driven by the driving circuit and which is arranged to repetitiously switch the switch on and off so as to provide a predefined percentage of the power available on the powerline in the selected half of the power cycle to the water pump, and that the driving circuit is arranged to maintain the switch in the on position for a selected period of time in the non-selected half of the power cycle present on the powerline, so as to enable that in said second half electrical current through the water pump restores to zero.

Accordingly, it is possible to vary the capacity of the water pump over the entire range between 0% and 100% electrical power. This arrangement also provides that electrical current spikes and RF emissions and losses are effectively prevented. This makes the hot beverage brewing apparatus of the invention particularly usable also in domestic, commercial and light industrial environments. Moreover, an acoustic noise reduction of at least 10 dB is achieved when operating the electrical pump according to the invention, which further promotes the use of the apparatus in the domestic environment.

According to the invention the single function hot beverage brewing apparatus of the prior art, is completed with a second function, i.e. the possibility to provide hot steam in addition to providing the hot beverage without the need to add an additional water pump or heating facilities. Accordingly in one housing it is possible to provide both the hot beverage brewing facility and the facility to provide hot water or steam.

Objects, advantages and novel features, and further scope of applicability of the present invention will be set forth in part in the detailed description to follow, taken in conjunction with the accompanying drawings, and in part will become apparent to those skilled in the art upon examination of the following, or may be learned by practice of the invention. The objects and advantages of the invention may be realized and attained by means of the instrumentalities and combinations particularly pointed out in the appended claims.

### BRIEF DESCRIPTION OF THE SEVERAL VIEWS OF THE DRAWINGS

The accompanying drawings, which are incorporated into and form a part of the specification, illustrate one or more embodiments of the present invention and, together with the description, serve to explain the principles of the invention. The drawings are only for the purpose of illustrating one or more embodiments of the invention and are not to be construed as limiting the invention. In the drawings:

FIG. 1 is a schematic illustration showing a control scheme for controlling the water pump of a hot beverage brewing apparatus according to an embodiment of the present invention;

FIG. 2 is a schematic illustration showing a control scheme according to what is shown in FIG. 1 with less detail, but completed with the control scheme for the steam supply with an apparatus according to an embodiment of the present invention.

### DETAILED DESCRIPTION OF THE INVENTION

Whenever in the figures the same reference numerals are applied, these numerals refer to the same parts.

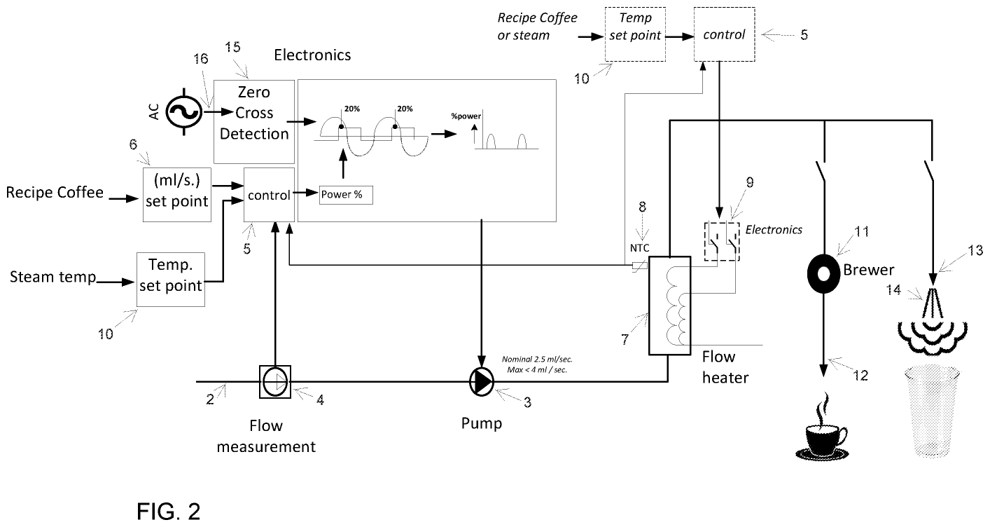

Turning first to FIG. 2 which depicts a control scheme of a hot beverage brewing apparatus 1 according to the invention, this figure further schematically shows that the apparatus comprises water input 2, water pump 3 connected to water input 2 and provided with a first control loop for controlling a flow generated by water pump 3. This first control loop comprises flow measurement device 4, controller 5, and of course water pump 3 itself. Setpoint 6 for waterflow can be provided to controller 5 in accordance with a selected recipe, for instance for coffee.

FIG. 2 further shows that apparatus 1 comprises thermal heater 7 connected to water pump 3 and that this thermal heater 7 is provided with a second control loop for controlling the heating by thermal heater 7 of the water supplied by water pump 3. This second control loop comprises thermistor 8 for measuring the temperature, the earlier mentioned controller 5 which for clarity of the figure is repeated in dashed lines, and electronics 9 providing power to thermal heater 7. Temperature setpoint 10 can be provided to controller 5.

Further FIG. 2 shows that there is brewer unit 11 connected to thermal heater 7 with first outlet 12 for the hot beverage. So far the features that are mentioned in this figure description concerning hot beverage brewing apparatus 1 of the invention are known from the prior art. The additional and novel feature according to the invention is that thermal heater 7 is provided with second outlet 13 for steam 14.

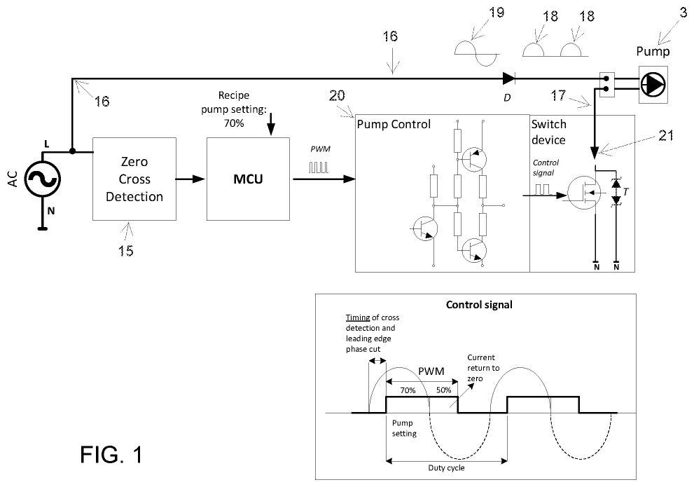

Other aspects of the invention are discussed in the following, also making reference to FIG. 1.

Hot beverage brewing apparatus 1 of the invention preferably has the feature that the first control loop for controlling the flow generated by water pump 3 comprises zero cross detection circuit 15 connected to power input line 16 of power circuit 17 which provides power to water pump 3 to detect and select one of the two halves 18 of power cycle 19 present on power line 16. The control loop further comprising driving circuit 20 cooperating with zero cross detection circuit 15, and said control loop further comprises switch 21 in power circuit 17 of water pump 3, which switch 21 is driven by driving circuit 20 and which is arranged to repetitiously switch switch 21 on and off so as to provide a predefined percentage of the power available on powerline 16 in the selected half 18 of power cycle 19 to water pump 3.

Preferably driving circuit 20 is further arranged to maintain switch 21 in the on position for a selected period of time in the non-selected half of power cycle 19 present on powerline 16, so as to enable that in said second half electrical current through water pump 3 restores to zero.

Although the invention has been discussed in the foregoing with reference to an exemplary embodiment of the hot beverage brewing apparatus of the invention, the invention is not restricted to this particular embodiment which can be varied in many ways without departing from the invention. The discussed exemplary embodiment shall therefore not be used to construe the appended claims strictly in accordance therewith. On the contrary the embodiment is merely intended to explain the wording of the appended claims without intent to limit the claims to this exemplary embodiment. The scope of protection of the invention shall therefore be construed in accordance with the appended claims only, wherein a possible ambiguity in the wording of the claims shall be resolved using this exemplary embodiment.

Embodiments of the present invention can include every combination of features that are disclosed herein independently from each other. Although the invention has been described in detail with particular reference to the disclosed embodiments, other embodiments can achieve the same results. Variations and modifications of the present invention will be obvious to those skilled in the art and it is intended to cover in the appended claims all such modifications and equivalents. The entire disclosures of all references, applications, patents, and publications cited above are hereby incorporated by reference. Unless specifically stated as being “essential” above, none of the various components or the interrelationship thereof are essential to the operation of the invention. Rather, desirable results can be achieved by substituting various components and/or reconfiguration of their relationships with one another.

What is claimed is:

1. A hot beverage brewing apparatus comprising:
a water input;
a water pump connected to the water input and comprising a first control loop for controlling a flow generated by the water pump;
a thermal heater connected to the water pump and comprising a second control loop for controlling the heating by the thermal heater of the water supplied by the water pump; and
a brewer unit connected to the thermal heater with a first outlet for the hot beverage;
wherein the thermal heater is provided with a second outlet for steam, and the first control loop for controlling the flow generated by the water pump comprises a zero cross detection circuit connected to a power input line of a power circuit which provides power to the water pump to detect and select one of the two halves of a power cycle present on the power line, the control loop further comprising a driving circuit cooperating with the zero cross detection circuit, and the control loop further comprising a switch in the power circuit of the water pump, which switch is driven by the driving circuit and which is arranged to repetitiously switch the switch on and off so as to provide a predefined percentage of the power available on the powerline in the selected half of the power cycle to the water pump, wherein the driving circuit is arranged to maintain the switch in the on position for a selected period of time in the non-selected half of the power cycle present on the powerline, so as to enable that in said second half electrical current through the water pump restores to zero.
